(19) United States
(12) Patent Application Publication
(10) Pub. No.: US 2020/0051397 A1
(43) Pub. Date: Feb. 13, 2020

(54) System and Method For Wagering in a Live Sports Social Media Environment

(71) Applicant: Samantha Jones, Memphis, TN (US)

(72) Inventor: Samantha Jones, Memphis, TN (US)

(21) Appl. No.: 16/057,884

(22) Filed: Aug. 8, 2018

(51) Int. Cl. G07F 17/32; G06Q 20/10

(52) U.S. Cl. CPC G07F 17/3288; G06Q 20/10; G07F 17/3244; G07F 17/323; G07F 17/3276

(57) ABSTRACT

The present invention discloses a system and method for wagering in a live sports social media environment. The system includes a device having a user interface, the device is in communication with a network. At least one server, in operable communication with a processor, has operable instructions to provide a wagering interface to a plurality of users, stream an event, and provide a means for wagering on the event.

### TECHNICAL FIELD

The embodiments presented provide a system and method for providing communications, media, and wagering interface for users over a network.

### BACKGROUND

The development and widespread use of the internet has resulted in a change in the way humans interact. This change can be seen in sports as fans receive updates and even watch sporting events via a live feed on their mobile devices. Some platforms even provide a collection of sports media all in one interface which enable the user to monitor a variety of sporting events simultaneously.

Traditionally, sporting events and sports betting have been around for hundreds, if not thousands, of years in one form or another. It is widely known that sports provide the fans an outlet for their competitive desires without directly competing in the sporting event itself. While the wagering industry has advanced along with current streaming technology, no single platform exists where users can engage with a variety of sports-related media, socialize with other fans, and place wagers on live sporting events streamed directly to their device in real-time.

It can be seen that advances in the arts related to real-time wagering within a social media sports environment is needed. One such advance is presented by the variety of embodiments provided herein.

### SUMMARY OF THE INVENTION

This summary is provided to introduce a variety of concepts in a simplified form that is further disclosed in the detailed description of the invention. This summary is not intended to identify key or essential inventive concepts of the claimed subject matter, nor is it intended for determining the scope of the claimed subject matter.

In one aspect, embodiments provided herein relates to a system for wagering in a live sports social media environment. The system is comprised of a device having a processor providing a user interface thereon. The device, along with at least one server, is in communication with a network. The wagering system, which provides a wagering interface, further includes a credit manager. The processor includes operable instructions to provide a wagering interface to a plurality of users while streaming an event. The processor further permits wagering between the group of users within the wagering interface.

In further aspects, the user interface can include a fantasy sports interface, a podcast interface, a marketplace interface, and/or a communications interface.

In one aspect, the communications interface includes a chat feature wherein users can publish communications within an ecosystem of users in addition to a wall feature, wherein published communications are aggregated in a pre-selected collaborative space or ecosystem.

In another aspect, a financial institution is in communication with the network, such that the financial institution includes a payment processing system to facilitate the transfer of wagers.

A method for providing a wagering interface in a social media environment includes the steps of providing, via a processor, a wagering interface and at least one of the following: a communications interface, a fantasy sports interface, a podcast interface, and a marketplace interface. The processor facilitates streaming, via third-party providers, an event to a group of users interacting with the wagering interface while facilitating wagers between the group of users. A means for payment, via a financial institution is provided using a payment processing system.

In one aspect, the marketplace interface provides goods and services from the plurality of third-party providers.

In another aspect, the event is a live sporting event streamed in real-time via the at least one third-party provider. Each user can wager on the live sporting event in real-time.

Moreover, in accordance with a preferred embodiment of the present invention, other aspects, advantages, and novel features of the present invention will become apparent from the following detailed description in conjunction with the drawings.

### BRIEF DESCRIPTION OF THE DRAWINGS

A more complete understanding of the present invention and the advantages and features thereof will be more readily understood by reference to the following detailed description when considered in conjunction with the accompanying drawings wherein:

FIG. 1 illustrates a block diagram of the network configuration related to the wagering system, according to an embodiment of the present invention;

FIG. 2 illustrates an exemplary screenshot of the wagering interface, according to an embodiment of the present invention;

FIG. 3 illustrates a screenshot of the home screen interface, according to an embodiment of the present invention;

FIG. 4 illustrates a screenshot of the podcast interface, according to an embodiment of the present invention;

FIG. 5 illustrates a screenshot of a sports media interface, according to an embodiment of the present invention;

FIG. 6 illustrates a screenshot of a sports media interface, according to an embodiment of the present invention;

FIG. 7 illustrates a screenshot of the content and messaging interface according to an embodiment of the present invention;

FIG. 8 illustrates a block diagram of the server configuration, according to an embodiment of the present invention; and

FIG. 9 illustrates a flowchart of a method of providing a wagering interface to an ecosystem of users, according to an embodiment of the present invention.

### DETAILED DESCRIPTION

The specific details of the single embodiment or variety of embodiments described herein are to the described system and methods of use. Any specific details of the embodiments are used for demonstration purposes only and not unnecessary limitations or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantage's” provided by some embodiments, other embodiments may not include those same advantages or may include different advantages. Any advantages described herein are not to be construed as limiting to any of the claims.

Before describing in detail exemplary embodiments, it is noted that the embodiments reside primarily in combinations of components related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The present invention can be embodied as a method, data processing system, or computer program product. Accordingly, the present invention may take the form of an entirely hardware embodiment, an entirely software embodiment, or an embodiment combining both software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized, including hard disks, USB Flash Drives, DVDs, CD-ROMs, optical storage devices, magnetic storage devices, etc.

Computer program code for carrying out operations of the present invention may be written in an object-oriented programming language e.g., Java, C++, etc.). The computer program code, however, for carrying out operations of the present invention may also be written in conventional procedural programming languages, such as the “C” programming language or in a visually oriented programming environment. The program code may execute entirely on the user's computer, partly on the user's computer, as a stand-alone software package, partly on the user's computer and partly on a remote computer or entirely on the remote computer or mobile computing device.

A remote computer may be connected to a user's computer through a local area network (LAN) or a wide area network (WAN), wireless data network e.g., WiFi or and cellular network or the connection may be made to an external computer via most third party supported networks (for example, through the Internet using an Internet Service Provider). A user's computer can include a portable electronic device, such as a smartphone or tablet computer, that can communicate wirelessly over data communications networks.

Computer program instructions may also be stored in a computer-readable memory that can direct a computer or other programmable data processing apparatus to function in a particular manner, such that the instructions stored in the computer-readable memory produce an article of manufacture, including instruction means which implement the function/act specified in the block or blocks. The computer program instructions can be loaded onto a computer or other programmable data processing apparatus. This causes a series of operational steps to be performed on the computer or other programmable apparatus to produce a computer implemented process such that the instructions which execute on the computer or other programmable apparatus provide steps for implementing the functions/acts specified in the block or blocks.

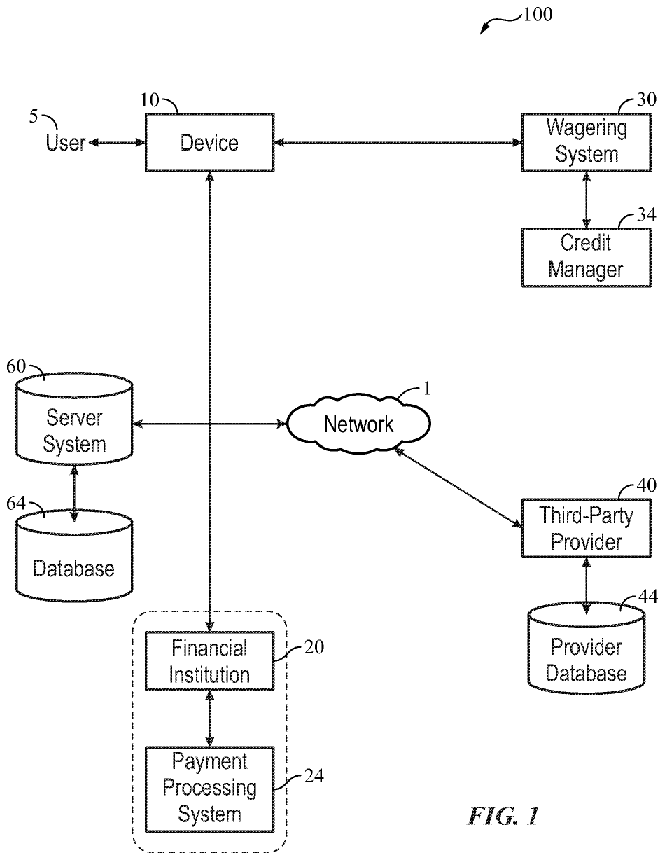

In general, and in reference to FIG. 1, the embodiments presented herein relate to a system 100 for providing a user interface related to sports content and wagering. The system 100 can be utilized by an ecosystem or community of users 5 to consume and interact with sports-related content, social media, media streams, wagering systems, and various other forms of content from any number of parties. A network 1 is in communication with any number of users 5 via at least one device 10 in communication with each user. The device can include a smartphone, tablet, computer, PDA, or similar computing device. A wagering system 30 permits each user to place a wager (e.g., a bet) on a sporting event. A credit manager 34 is in communication with the wagering system 30 to store and interpret credits owned by the user 5. A financial institution 20 provides a payment processing system 24 to the user 5 and facilitates monetary transactions throughout the network 1. Any number of third-party providers 40 are in communication with the network 1. Each third-party provider 40 can include a provider database 44 to store and transmit data.

Third-party providers can include media outlets, internet providers, social media interfaces, online marketplaces, podcast interfaces, communication interfaces, and other web-based information and interaction interfaces.

A server system 60 and database 64 store, transmit, and receive information related to system 100. Computer readable instructions can be processed by a processor which can include any commercially available or custom microprocessor, microcontroller, digital signal processor or the like. The database 64 may include any memory devices containing the software and data used to implement the functionality circuits or modules used in accordance with embodiments of the present invention. The database 64 can include but is not limited to, the following types of devices: cache, ROM, PROM, EPROM, EEPROM, flash memory, SRAM, DRAM and magnetic disk. In some embodiments of the present invention, the database 64 may be, for example, a content addressable memory (CAM).

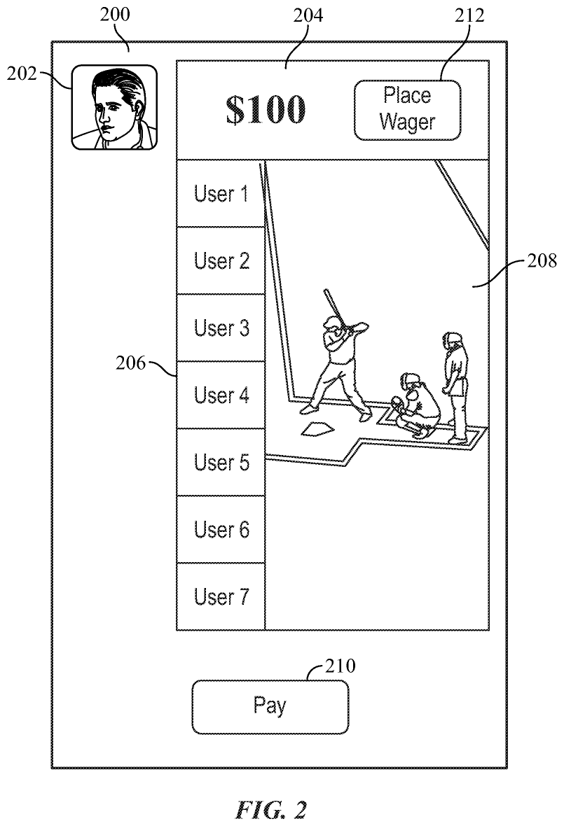

Now referring to FIG. 2, a wagering interface 200 is illustrated. The wagering interface 200 provides a video chat 202 which permits two or more users 5 within the wagering group 206 to communicate with one another using video and/or audio transmission of data. The wagering group 206 consists of a list of users 5 (shown as user's 1-7) which are engaged in a live sports wagering ecosystem. Each user 5 can engage with a media stream 208 of an event. Each user 5 has a total 204 corresponding to their amount of available credits with which they can wager. A total wager can be displayed to the group 206. Each user 5 can independently select to place a wager using the place wager icon 212. The user can then enter an amount to wager as well as parameters associated with the wager. Following the event, the user can select the pay icon 210 to pay their wager(s) which is/are due.

Events that can be streamed include sporting events such as a horse race, an auto race, a boxing match, a kickboxing match, an ultimate fight match, a wrestling match, a basketball game, a soccer game, a rugby game, a football game, a baseball game, a hockey game, a lacrosse match, a dog race, golf tournament, and other skill-based games and common wagering events.

The streamed event may be broadcast in real-time along with audio commentary and audio media provided by the stream.

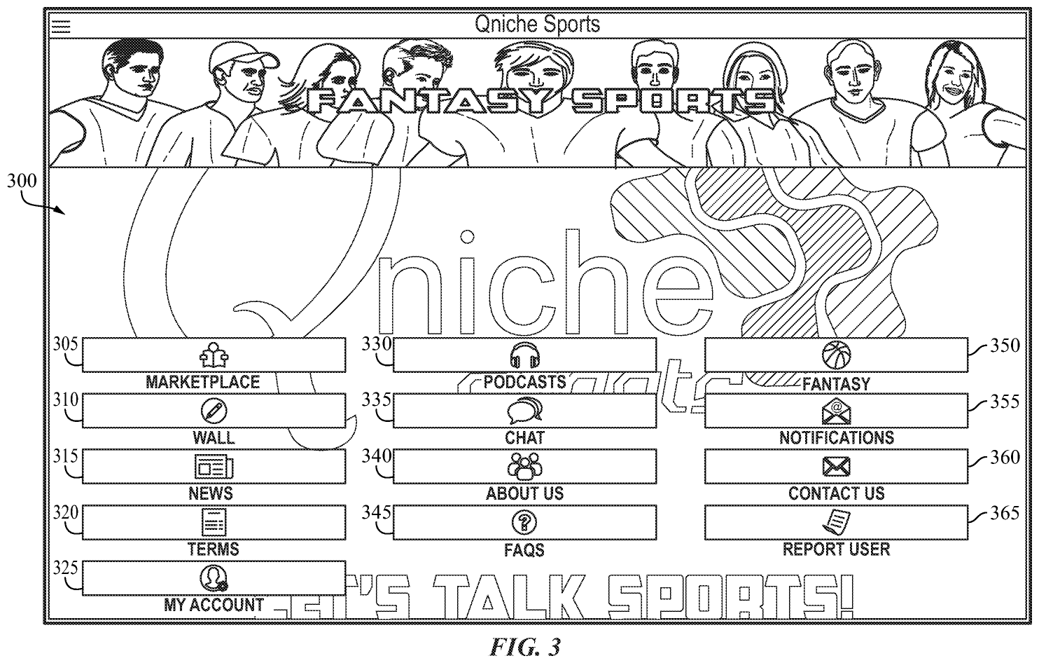

FIG. 3 illustrates a home screen graphical user interface (GUI) 300 for the system 100 having a plurality of selectable icons thereon. In the exemplary embodiment provided, the GUI 300 includes a marketplace icon 305, wall icon 310, news icon 315, terms icon 320, account icon 325, podcast icon 330, chat icon 335, about icon 340, FAQ's icon 345, fantasy icon 350, notification icon 355, contact icon 360, and report user icon 365. Functions and processes of each icon presented on the GUI 300 are readily apparent to those skilled in the arts unless otherwise indicated in the description provided herein.

The marketplace icon 305 can transmit data to the user 5 to a native interface or external system wherein the user 5 can interact with a marketplace 305. A marketplace 305 can include an online retailer, online service provider, an online wagering system, or other interface wherein commerce between the user 5 and a third-party can be performed.

The wall icon 310 can include a query of communications cultivated within the ecosystem of users 5. The user 5 can have the preference of determining which users 5 within the ecosystem appear on the wall interface. The wall icon 310 can be in communication with the chat icon 335 to facilitate the communication and publishing of user interactions throughout the ecosystem of users.

The news icon 315 can include news data transmitted by the third-party provider 40, or data aggregated from the ecosystem of users 5.

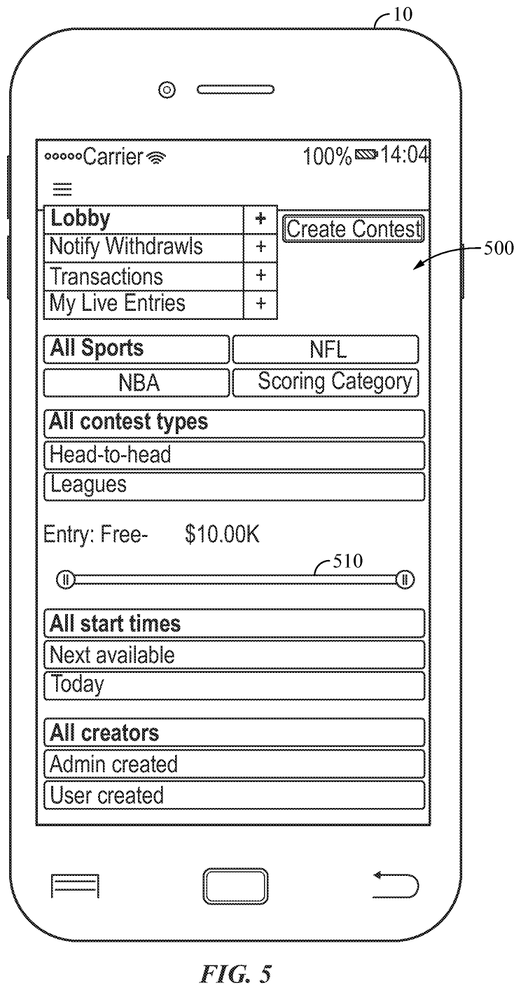

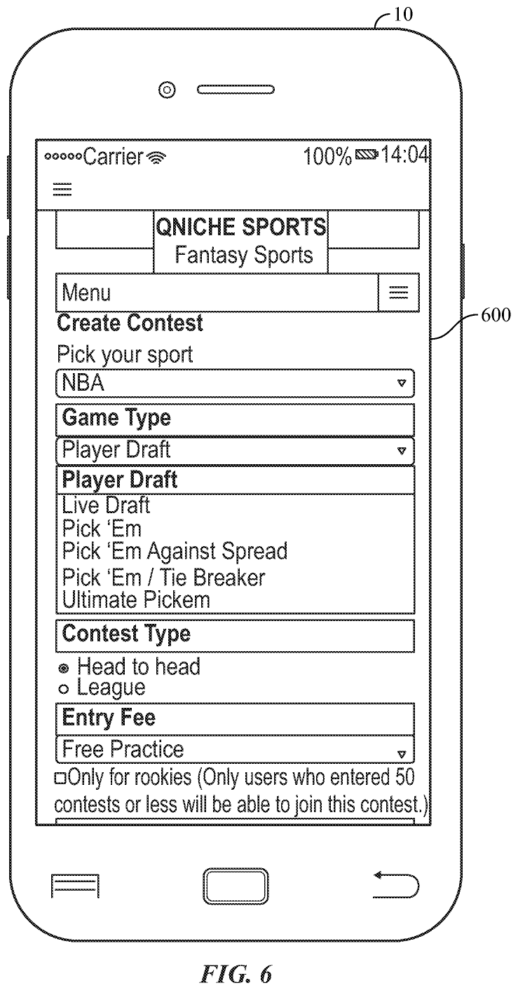

The fantasy icon 350 can include an interface for interacting in fantasy sports interfaces (illustrated in FIG. 5 and FIG. 6). The fantasy icon 350 can transmit data from third-party providers 40 which are involved in fantasy sports systems as commonly known in the arts.

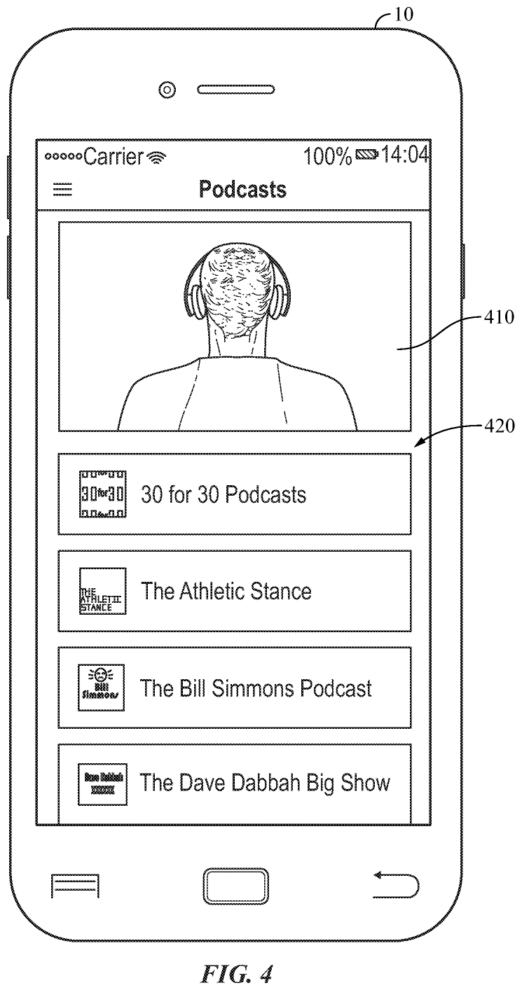

FIG. 4 illustrates a podcast interface 410 presented on the user interface of the device 10. The podcast interface 410 can be transmitted from the system database 64 or a third-party provider database 44. Data can include podcast content 420 provided within the podcast interface 410 permitting each user to select from a list of podcasts and stream content to the device 10.

FIG. 5 and FIG. 6 illustrate fantasy sports interfaces 500, 600 which provide the user 5 means for interacting with a community of fantasy sports users. Each user 5 can select from a variety of fantasy sports settings and preferences known in the arts. This can include entry fee amounts 510, sport, league, dates and times, contest type, among other parameters.

The system enables users 5 to create a password-protected user account that grants access to the various features of the system 100. One aspect of the system 100 enables a registered user to set preferences for their interaction with the system 100. Interactions can include those with the wagering interface 200, or fantasy interfaces 500, 600. The preferences can include those to selectively create and define a targeted user community whereby each user within the community will be a player in a respective league or a member of a wagering group. The community design feature of the game advantageously enables the user 5 to selectively determine the rules applied to the community and the particular interaction or games being played by the community. The interaction may be a fantasy sports betting game whereby the users in the community compete against one another in monetary wagering contests without actually wagering or paying legal tender using the rules selected by the user 5.

In one embodiment, the user 5 may also selectively determine the type of sporting events that will be available to each player for purposes of betting. For example, the user 5 may determine that a particular league should only bet on the outcome of football games played in the National Football League. The system enables the user 5 to select from a plurality of different types of sporting contests that are available during the gaming period thus allowing users 5 to bet on various sporting events in different sports leagues during the betting periods and the gaming periods. A user 5 may also determine a subset of contests selected from a plurality of different type of sporting contests for use during a particular betting period.

In another embodiment, the user 5 may also selectively determine the type and nature of bets able to be placed by the user during the betting period. There are many known types of bets including but not limited to parlays, teasers, run line bets, over/under, progressive parlays, and head-to-head bets. The respective type of bets available and associated with a particular sporting contest are displayed to a player in the game, and the player can select the type of bet they want to place from the group of bet types presented. The parameters of each of the types of bets presented to the user may be selectively determined by the system operator in a known manner. The parameters include but are not limited to the spread, the over/under, number of teams able to be used in at least one of a parlay and a teaser, etc. Alternatively, the server implementing the game may connect, via a communication network to a remote source whereby these parameters can be acquired for presentation to the user 5.

In another embodiment, the system 100 enables the creation and definition of rules for a game period during which the players in the community have opportunities to make bets on actual sporting contests and events within individual sporting contests. In creating a game, the user 5 may select from a predetermined set of rules stored in a rules repository on a server or other storage device. Alternatively, the user 5 may create rules different from the predetermined set of rules. The rules available to the user 5 advantageously enable the user 5 to determine every aspect of the game to be played. The user 5 may choose a minimum or a maximum value that is available for each user 5.

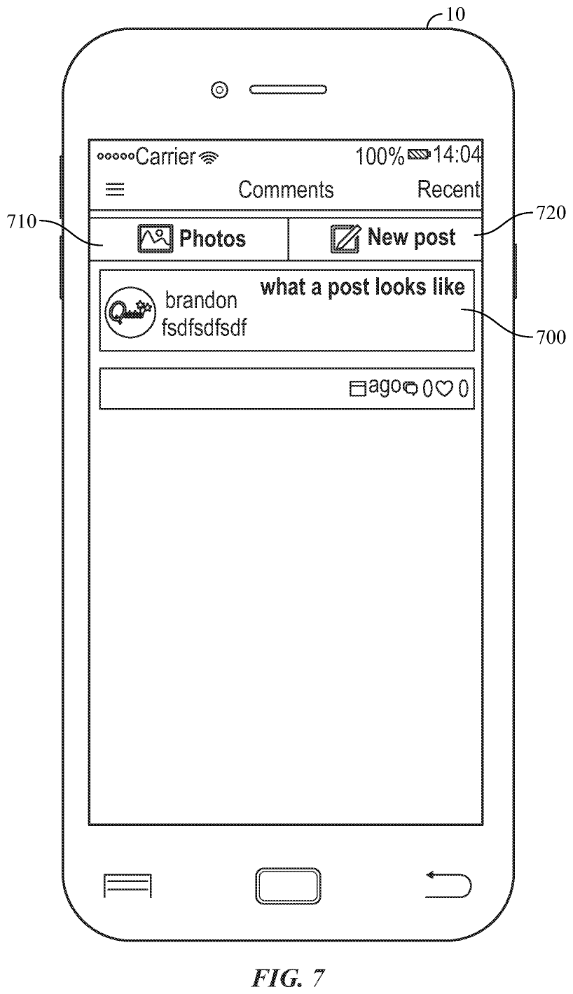

FIG. 7 illustrates an exemplary content interface 700 wherein users can submit posts, comments, or other content for publication to the ecosystem of users. The content interface 700 can include input fields for a variety of media including text, video, images, audio, and other content delivery means known in the arts.

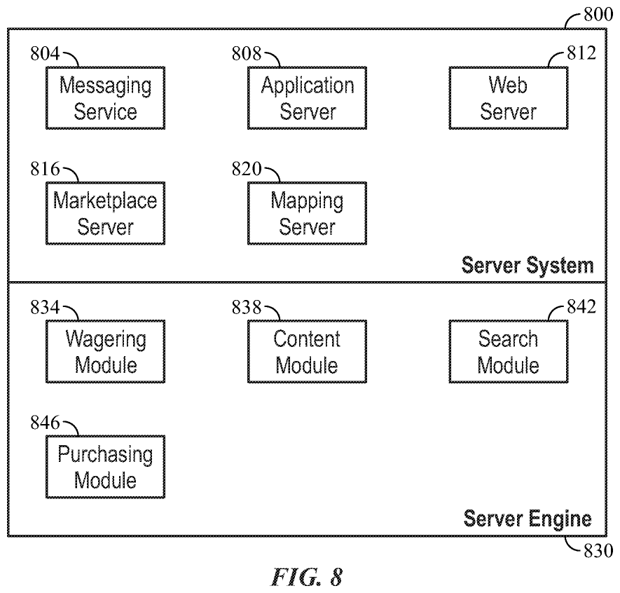

FIG. 8 illustrates a server system 800 including a messaging server 804, application server 808, web server 812, marketplace server 816, and mapping server 820. The server engine 830, having computer readable instructions provided by the processor includes a wagering module 834, content module 838, search module 842, and purchasing module 846. While each module is illustrated in a single data processing system, as will be appreciated by those of skill in the art, such functionality may be distributed across one or more data processing systems. Thus, the present invention should not be construed as limited to the configuration illustrated in FIG. 8 but may be provided by other arrangements and/or divisions of functions between data processing systems. For example, although FIG. 8 is illustrated as having various modules, one or more of these modules may be combined without departing from the scope of the present invention.

In one embodiment, the wagering module 834 permits each user 5 to place a wager on an event as known in the arts. This can include a variety of sports wagering schemes depending on community settings or user 5 preferences. The wagering module 834 is in communication with the wagering interface 200 wherein each of the plurality of users 5 can place a wager on the live event. The wagering module 834 tracks and updates the total 204 for each user 5 while new wagers are submitted.

The content module 838 permits communication between the ecosystem of users 5 including the video chat 202 interfaces within the wagering interface 200.

The search module 842 permits the user to search for content within the system 100. Content can include user-generated content, media, wagers, sports leagues and information thereof, fantasy leagues and information thereof, or any other commonly searchable data within the system 100.

The purchasing module 846 can include is in communication with third-party and native providers to facilitate the exchange of good and services. The purchasing module 846 may be in communication with any number of users 5, financial institutions 20, payment processing systems 22, and third-party providers 40.

It can be appreciated that modules 834, 838, 842, and 846 can communicate with one another to perform particular instructions and may be instituted as separate application programs (e.g., a mobile application) or as a single application or program.

In one embodiment, the system 100 can further include a GPS module to track and store information related to the location of each user 5 within the environment. The GPS module can facilitate processes for sending and receiving location data between users 5.

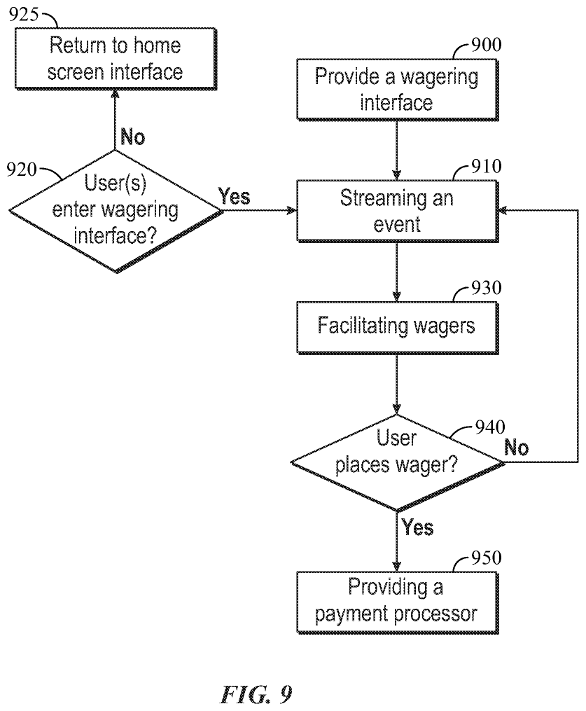

FIG. 9 illustrates a method for providing a wagering interface to a group of users 5. In step 900 a wagering interface is provided via operable instructions of the processor while an event is streamed in step 910. Users have the option to enter the wagering interface in step 920. If they elect not to enter the wagering interface, the user(s) is/are returned to the home screen interface or another interface within the system. In step 930 the system facilitates wagers. If a wager is placed (step 940) a payment processor is provided in step 950. Alternative interfaces as described hereinabove may be provided while the wagering interface is engaged with.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for wagering in a live sports social media environment, the system comprising:
a. a device having a processor configured to provide a user interface thereon, the device in communication with a network; and
b. at least one server in communication with the network, the processor having operable instructions to perform the following:
i. providing a wagering interface to a plurality of users;
ii. streaming an event such that the event is provided on the wagering interface; and
iii. wagering, via the users, on the event.

2. The system of claim 1, wherein the user interface includes a fantasy sports interface.

3. The system of claim 1, wherein the user interface includes a podcast interface.

4. The system of claim 1, wherein the user interface includes a communications interface.

5. The system of claim 4, wherein the communications interface includes the following:
a. a chat feature, wherein a plurality of users can publish communications within an ecosystem of users; and
b. a wall feature, wherein published communications are aggregated.

6. The system of claim 1, wherein the user interface includes a marketplace interface.

7. The system of claim 1, further comprising a financial institution in communication with the network, wherein the financial institution includes a payment processing system to facilitate the transfer of wagers.

8. The system of claim 1, wherein the wagering interface consults a credit manager configured to stored credit data of the ecosystem of users.

9. A system for wagering in a live sports social media environment, the system comprising:
a. a device having processor providing a user interface thereon, the device in communication with a network;
b. a wagering system including a credit manager, the wagering system configured to provide a wagering interface to a plurality of users; and
c. at least one server in communication with the network, the processor having operable instructions to perform the following:
i. providing a wagering interface to a plurality of users;
ii. streaming an event such that the event is provided on the wagering interface; and
iii. wagering, via the users, on the event.

10. The system of claim 9, wherein the user interface includes a fantasy sports interface.

11. The system of claim 9, wherein the user interface includes a podcast interface.

12. The system of claim 9, wherein the user interface includes a communications interface.

13. The system of claim 12, wherein the communications interface includes the following:
a. a chat feature, wherein a plurality of users can publish communications within an ecosystem of users; and
b. a wall feature, wherein published communications are aggregated.

14. The system of claim 9, wherein the user interface includes a marketplace interface.

15. The system of claim 9, further comprising a financial institution in communication with the network, wherein the financial institution includes a payment processing system to facilitate the transfer of wagers.

16. A method for providing a wagering interface in a social media sports environment, the method comprising:
a. providing, via a processor, a wagering interface and at least one of the following:
i. a communications interface;
ii. a fantasy sports interface;
iii. a podcast interface; and
iv. a marketplace interface.
b. streaming, via a plurality of third-party providers, an event to a group of users interacting with the wagering interface;
c. facilitating wagers between a group of users, wherein the wagers are dependent on the event; and
d. providing, via a financial institution, a means for payment via a payment processing system.

17. The method of claim 16, wherein the communications interface includes the following:
a. a chat feature, wherein a plurality of users can publish communications within an ecosystem of users; and
b. a wall feature, wherein published communications are aggregated.

18. The method of claim 16, wherein the marketplace interface provides goods and services from the plurality of third-party providers.

19. The method of claim 18, wherein the event is a live sporting event streamed in real-time via the at least one third-party provider.

20. The method of claim 16, wherein each user within the group of users can wager on the event in real-time.
